(19) United States
(12) Patent Application Publication
(10) Pub. No.: US 2005/0062929 A1
(43) Pub. Date: Mar. 24, 2005

(54) Eyeglass device with integral magnetic means for securing auxiliary lenses to eyeglass lenses

(75) Inventor: Simon Ping Sun Ng, Kowloon (CN)

Correspondence Address: ALIX YALE & RISTAS LLP, 750 MAIN STREET, SUITE 1400, HARTFORD, CT, 06103, US

(73) Assignee: Auto-Winner Limited

(21) Appl. No.: 10/670,492

(22) Filed: Sep. 24, 2003

(51) Int. Cl. G02C 9/00

(52) U.S. Cl. 351/47

(57) ABSTRACT

The invention involves an eyeglass mountable auxiliary lens device. The present device attaches at least partially to the eyeglasses through magnetic interaction and provides among other things a close fitting and aesthetically pleasing union between the eyeglasses and the auxiliary frames.

### BACKGROUND OF THE INVENTION

The present invention relates in general to eyeglasses and auxiliary lenses for attachment to eyeglasses.

Various means to attach auxiliary lenses to eyeglasses have been proposed over the years. However, these means typically utilize clips that are permanently attached to the auxiliary lenses. The clips then attach to the eyeglass frames. Other means to attach auxiliary lenses to eyeglasses include magnets or magnetic material attached to both the auxiliary and eyeglass frames and which engage each other to hold the auxiliary frames in place. These conventional arrangements for attaching to auxiliary lenses to eyeglasses have several drawbacks in that they are unattractive, require heavy frames, and are not closely associated with the eyeglasses and thus have large gaps between the auxiliary lenses and eyeglass frames that allow light refraction to interfere with vision. In addition, the shape of the eyeglass frames and the auxiliary frames are quite different, changing considerably the look of the eyeglasses when the two are attached in combination. Furthermore the use of magnets on both the primary and the auxiliary frames often lead to a situation where during manufacture of the devices the poles of the magnets are mismatched and thus non-operative. The use of magnets on both the primary and the auxiliary frames also prevents the auxiliary frames from being used interchangeably on other frames.

### SUMMARY OF THE INVENTION

Briefly stated, the present invention in a preferred form is generally directed toward the attachment of auxiliary lenses to eyeglasses. In particular, the present invention includes a device by which auxiliary lenses are associated with magnetic elements that attach to the eyeglasses.

The present invention includes a primary eyeglass frame for supporting primary lenses therein. The primary eyeglass frame may have two primary side members each extending outwardly and rearwardly from the frame, and to which are pivotably attached arms.

A secondary eyeglass frame for supporting secondary lenses therein, said secondary eyeglass frame including magnetic elements mounted rearwardly from said secondary frame for engaging said primary eyeglass frame so as to secure the secondary eyeglass frame to the primary eyeglass frame.

It is an object of the present invention to provide an eyeglass device to secure auxiliary lenses to an eyeglass frame that overcomes at least some of the above mentioned problems or provides the public with a useful alternative.

### BRIEF DESCRIPTION OF THE DRAWINGS

Other objects and advantages of the invention will be better understood to one of ordinary skill in the art from the following description made with reference to accompanying drawing in which:

FIGS. 1A through D shows top, front, and side views of an eyeglass device having magnetic elements in the nose pad arm area in accordance with the present invention.

FIGS. 2A through D shows top, front, and side views of an eyeglass device having magnetic elements in the side area in accordance with the present invention.

FIGS. 3A through D shows top, front, and side views of an eyeglass device having magnetic elements in the top area in accordance with the present invention.

### DESCRIPTION OF THE PREFERRED EMBODIMENT

Briefly stated, the invention in a preferred form is an eyeglass accessory that is simple in structure and provides the advantageous association of secondary lenses with the primary lenses of eyeglasses. In particular and referring to the drawings in detail, there is shown an eyeglass device 10 in accordance with the invention having an eyeglass frame 12 for supporting primary lenses 14 thereon. The eyeglass frames 12 may include a nose or bridge 34 that generally curves upwardly and outwardly from the plane of the frame 12. The area near the bridge 34 may be and attachment point for nose pad arms 80 which hold in place nose pads 82. The eyeglass frame 12 may include two side portions or members 16 extending outwardly and rearwardly therefrom for pivotally coupling arms 18 thereto.

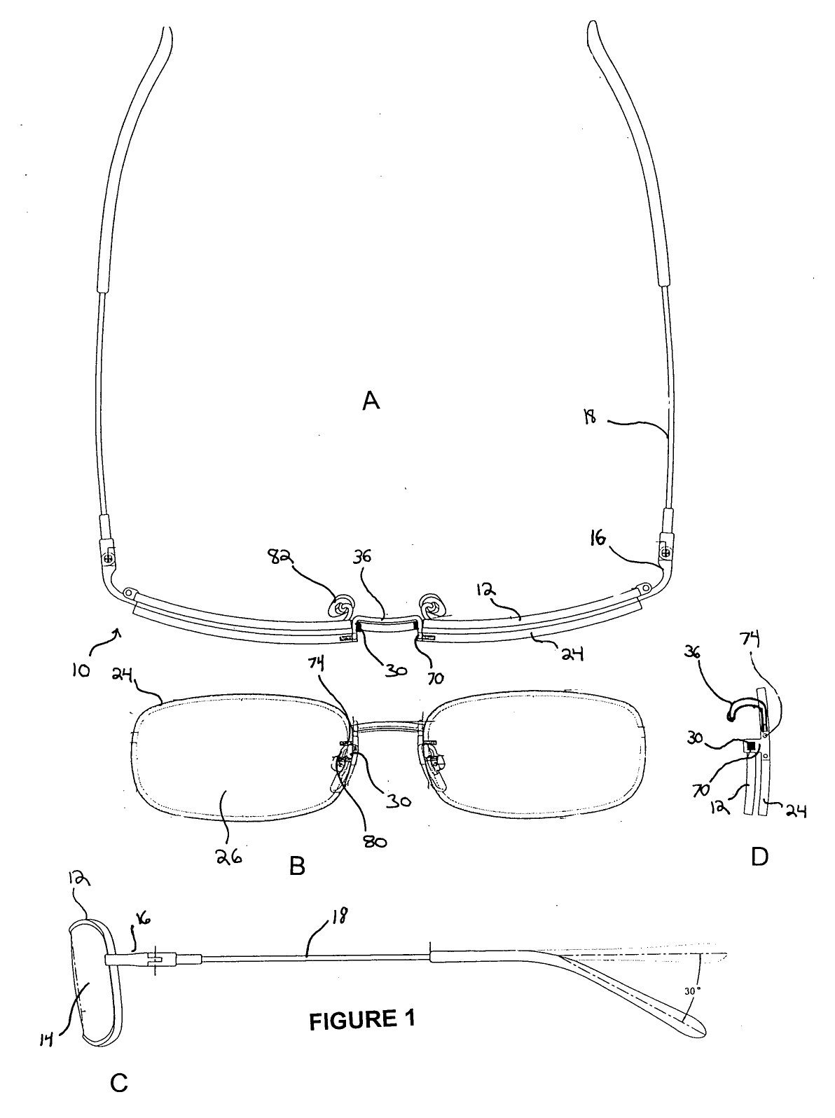

An auxiliary frame 24 can be correspondingly shaped in general to the eyeglass frame 12. The auxiliary frames 24 include a nose or bridge 36 that extends upwardly and rearwardly form the line of the frame. The auxiliary frames 24 may also include includes extension members 70 extending outwardly and rearwardly therefrom. The auxiliary frame 24 includes, in one embodiment of the invention, magnetic members 30 secured to, for example, the rearward part of extension members 70. The magnetic members 30 engage with the eyeglass frame 12, such that the auxiliary frames 24 are supported by the eyeglass frames, for example, as shown in FIG. 1. Generally, the magnetic members 30 may be fitted in cavities in the extension members 70, or they may be manufactured integrally with the members. The bridge 36 of the auxiliary frame may be integral with extension members 70, for example as in FIG. 1D. The bridge 36 and extension member 70 assembly may support the auxiliary lenses 26 by screws 74 that penetrate into the lenses 26.

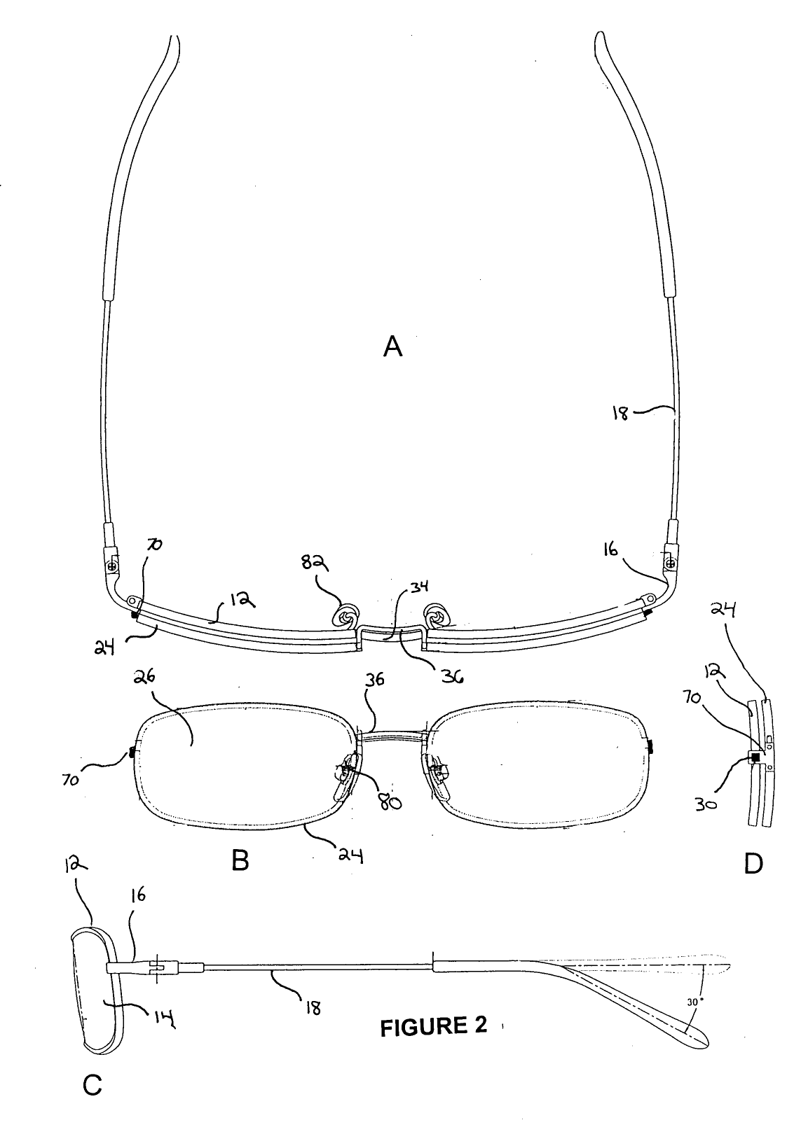

In one embodiment of the invention, as shown in, for example, FIGS. 2A-2D, the magnetic elements 30 of the auxiliary frame 24 may be located on the side portion of the auxiliary frame 12. The magnetic members 30 may be affixed, embedded, or other wise associated with extensions 70 that position the magnetic members to the rear of the auxiliary frame 24. The magnetic members 30 may then magnetically interact with the eyeglass frame 12 having magnetic properties. The bridge 34 of the eyeglasses and the bridge 36 of the auxiliary frame may be configured with the auxiliary frame bridge 36 being positioned rearwardly along with the eyeglass frame bridge 34 as shown in, for example, FIG. 2A. This configuration, among other things, ensures that the original design lines of the eyeglasses are not markedly changed when the auxiliary frame 24 is secured to the eyeglass frames 12.

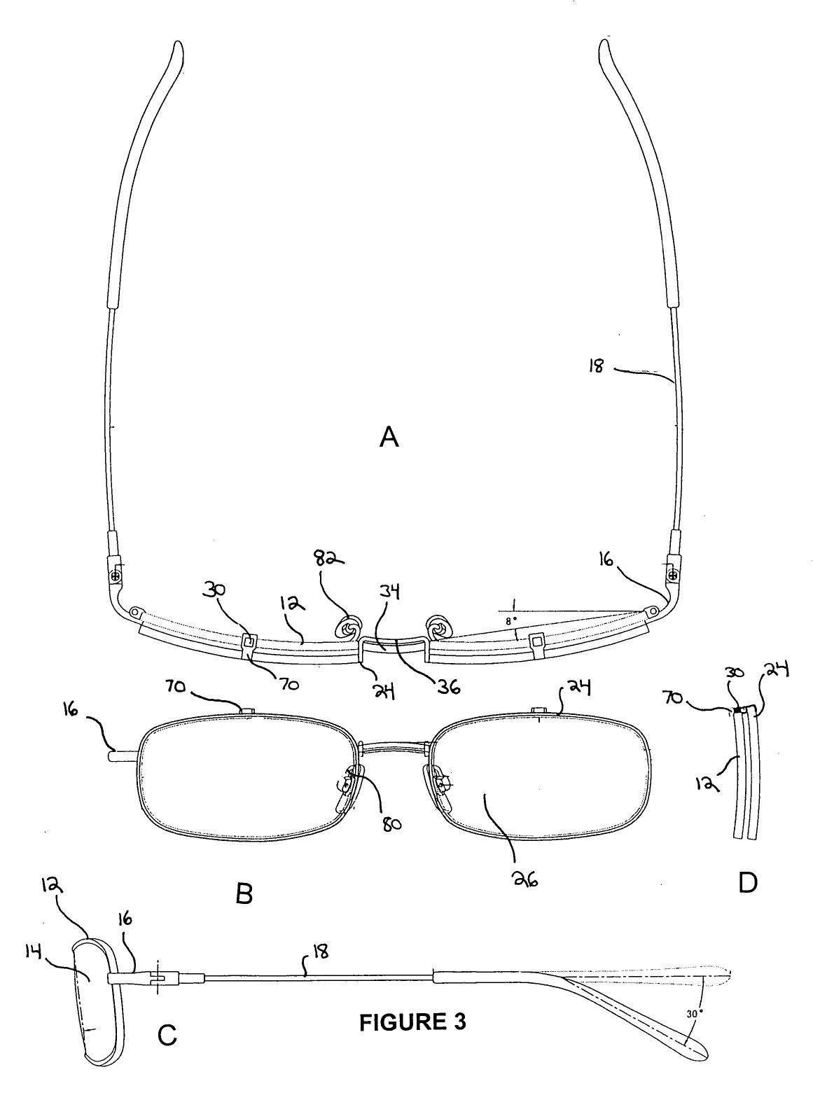

In another embodiment of the invention, as shown in, for example, FIGS. 3A-3D, the magnetic elements 30 of the auxiliary frame 24 may be located on the upper portion of the auxiliary frame 12. The magnetic members 30 may be affixed, embedded, or other wise associated with extensions 70 that position the magnetic members to the rear of the auxiliary frame 24. The extensions 70 may be attached directly to the secondary lenses 26. The magnetic members 30 may then magnetically interact with the eyeglass frame 12 which has magnetic properties. This configuration, among other things, ensures that the original design lines of the eyeglasses are not markedly changed when the auxiliary frame 24 is secured to the eyeglass frames 12.

In still another embodiment of the invention, the magnetic elements 30 of the auxiliary frame 24 may be located below the bridge 36, for example as in FIG. 1D, of the auxiliary frame 24. The magnetic members may be affixed, embedded, or other wise associated with extensions 70 that position the magnetic members 30 to the rear of the auxiliary frame 24. The extensions 70 may be attached directly to the secondary lenses 26 such as with screws 74. The magnetic members 30 may then magnetically interact with the eyeglass frame 12 having magnetic properties. This configuration, among other things, ensures that the original design lines of the eyeglasses are not markedly changed when the auxiliary frame 24 is secured to the eyeglass frames 12.

The close integration of auxiliary frames 24 and the eyeglass frames 12 has many advantages, for instance, it reduces the overall weight of the device, reduces light entering from the side between the primary lens 14 and the auxiliary lens 26, and minimizes any change in the design look of the eyeglass frames.

While the preferred embodiments have been shown to describe the invention, various modifications and substitutions may be made thereto without departing from the spirit and scope of the invention. Accordingly, it is to be understood that the present invention has been described by way of illustration and not limitation.

1. An eyeglass apparatus comprising:
a primary eyeglass frame having a rear side, a pair of primary lens supports, and a bridge between the primary lens supports;
a secondary eyeglass frame having a rear side, a pair of secondary lens supports, a bridge between the secondary lens supports, a first secondary frame magnet fixed to a first projecting magnet holder, and a second secondary frame magnet fixed to a second projecting magnet holder; and
said first and second secondary frame magnets magnetically bond with portions of the primary frame to retain said secondary frame to said secondary frame.

2. The eyeglass apparatus of claim 1, wherein said first and second secondary frame magnets selectively interact attractively with the primary frame at the primary lens supports.

3. The eyeglass apparatus of claim 2, wherein said first and second secondary frame magnets selectively interact attractively with the primary frame at the top portion of the primary lens supports.

4. The eyeglass apparatus of claim 1, wherein said first and second secondary frame magnets selectively interact attractively with the primary frame at a nose pad arm area of the primary frame.

5. The eyeglass apparatus of claim 1, wherein said first and second secondary frame magnets selectively interact attractively with the primary frame at the sides of the primary frame.

6. The eyeglass apparatus of claim 1, wherein the first projecting magnet holder and the second projecting magnet holder both have cavities for receiving the first secondary frame magnet and the second secondary frame magnet.

7. The eyeglass apparatus of claim 1, wherein the first projecting magnet holder and second projecting magnet holder project from the rear side of the secondary eyeglass frame.

8. The eyeglass apparatus of claim 1, wherein the first projecting magnet holder and the second projecting magnet holder are attached to the eyeglass lenses.

9. The eyeglass apparatus of claim 8, wherein the first projecting magnet holder and the second projecting magnet holder are attached with screws that penetrate into the lenses.

10. The eyeglass apparatus of claim 1, wherein the first projecting magnet holder and the second projecting magnet holder are integral to the bridge of the secondary eyeglass frame, and said eyeglass lenses are attached directly to the first projecting magnet holder and the second projecting magnet holder.

11. The eyeglass apparatus of claim 1, wherein the primary frame and the secondary frame are of a similar size and configuration.
